(19) United States
(12) Patent Application Publication
(10) Pub. No.: US 2008/0023405 A1
(43) Pub. Date: Jan. 31, 2008

(54) Water filtration systems and methods

(75) Inventors: James Rulon Young Rawson, Clifton Park, NY (US); Shane Alan Gernand, Glenville, NY (US); Brian Christopher Moore, Rexford, NY (US); Raul Eduardo Ayala, Clifton Park, NY (US); Philip Mathew Rolchigo, Clifton Park, NY (US)

Correspondence Address: JOHN S. BEULICK (13307), ARMSTRONG TEASDALE LLP, ONE METROPOLITAN SQUARE, SUITE 2600, ST. LOUIS, MO, 63102-2740, US

(73) Assignee: General Electric Company

(21) Appl. No.: 11/638,006

(22) Filed: Dec. 13, 2006

Related U.S. Application Data
(60) Provisional application No. 60/834,237, filed on Jul. 28, 2006.

(51) Int. Cl. C02F 1/42

(52) U.S. Cl. 210/688; 210/912; 210/290

(57) ABSTRACT

A filter for removing soluble and insoluble lead from water supplied by a water source includes at least one charged filter medium configured to facilitate removing at least one of soluble lead and insoluble colloidal lead from the water.

### CROSS REFERENCE TO RELATED APPLICATIONS

This application claims the benefit of U.S. provisional application No. 60/834,237 filed Jul. 28, 2006, which is hereby incorporated by reference in its entirety.

### BACKGROUND OF THE INVENTION

This invention relates generally to water filtration systems and, more particularly, to water filtration systems configured to remove lead and other contaminants from water supplied by a water source.

In general, insoluble lead particles may be removed by mechanical filtration methods provided the filter has pores small enough to exclude the insoluble lead particles. Separation efficiency is increased with filters containing smaller pore sizes, although higher pressures are needed to maintain flow through the filter. In the case of residential water purification, however, the mechanical filtration of insoluble lead cannot be done at pressures higher than those existing at the building point of entry (POE), typically 60 psi. Moreover, in some point of use (POU) lead filters, such as pitcher filters, there is no pressure driving force through the filter except for gravity, and so high efficiency mechanical filtration methods are not suitable for such application. Alternative practical solutions to the removal of insoluble lead are needed in residential water applications.

As much as about 40% to about 60% of the lead in drinking water may be insoluble and exist as colloidal or particulate matter. This colloidal lead exists as particles in the micron and sub-micron size. Lead is often released into drinking water distribution systems from municipal distribution lead pipes, brass fixtures and/or lead-based solders. The U.S. Environmental Protection Agency (USEPA) has set the action level for lead in drinking water at 15 micrograms/L (μg/L). When drinking water systems are devoid of materials that contain lead, this concentration of lead can be easily achieved. However, when lead is present in a drinking water distribution system, the total concentration of lead in the drinking water can often exceed the USEPA action level for lead. Therefore, consumers may install a POU filter to facilitate removal of a sufficient amount of lead from the drinking water to meet the USEPA action level for this contaminant. However, in the past, it was generally not recognized that a substantial quantity of insoluble colloidal lead had to be removed from drinking water to meet the USEPA action level for lead. Therefore, POE filters and POU filters configured to remove lead must be capable of removing both insoluble colloidal lead and soluble lead from residential drinking water.

### BRIEF DESCRIPTION OF THE INVENTION

In one aspect, a filter is provided for removing soluble and insoluble lead from water supplied by a water source. The filter includes at least one charged filter medium configured to facilitate removing at least one of soluble lead and insoluble colloidal lead from the water.

In a further aspect, a filter assembly is provided. The filter assembly is coupled to a water distribution system for removing soluble and insoluble lead from a water source. The water distribution system includes a filter assembly cap in fluid communication with the water source and defining an inlet and an outlet. The filter assembly includes a filter housing coupled to the filter assembly cap and in fluid communication with the water source. The filter housing is configured to receive unfiltered water through the inlet. A filter is positioned within the filter housing. The filter includes at least one charged filter medium configured to facilitate removing insoluble colloidal lead from the water.

In a further aspect, a method is provided for removing soluble and insoluble lead from water supplied by a water source. The method includes operatively coupling a filter assembly to the water source. The filter assembly includes a housing in fluid communication with the water source and configured to receive unfiltered source water. A filter is contained within the housing. The filter includes at least one charged filter medium configured to facilitate removing insoluble colloidal lead from the source water. Insoluble colloidal lead is removed from the source water as the source water is filtered through the at least one charged filter medium.

### BRIEF DESCRIPTION OF THE DRAWINGS

FIG. 1 is an exploded sectional view of a water distribution system including an exemplary filter assembly having a dual stage filter with charged adsorption media.

FIG. 2 is a cross-sectional view of the dual stage filter shown in FIG. 1 along sectional line A-A.

FIG. 3 is an exploded sectional view of a water distribution system including an alternative exemplary filter assembly having a dual stage filter with charged adsorption media.

FIG. 4 is a cross-sectional view of the dual stage filter shown in FIG. 3 along sectional line B-B.

FIG. 5 is an exploded sectional view of a water distribution system including an alternative exemplary filter assembly having a filter including a support matrix and charged adsorption media.

FIG. 6 is a cross-sectional view of the filter shown in FIG. 5 along sectional line C-C.

FIG. 7 is a cross-sectional view of an exemplary filter including a support matrix and adsorption media.

### DETAILED DESCRIPTION OF THE INVENTION

The present invention provides a system and method for removing lead and other contaminants from water supplied by a water source to provide filtered drinking water suitable for consumption. By directing the source water through a filter assembly, at a point of entry (POE) or at a point of use (POU), soluble lead and insoluble colloidal or particulate lead, as well as other undesirable contaminants, are removed from the source water to provide filtered drinking water suitable for consumption. More specifically, positively charged soluble lead is removed and adsorbed by at least one negatively charged filter medium and negatively charged insoluble colloidal or particulate lead is removed and adsorbed by at least one positively charged filter medium.

The present invention is described below in reference to its application in connection with and operation of a residential water filtration system. However, it should be apparent to those skilled in the art and guided by the teachings herein provided that the invention is likewise applicable to any water filtration system including, without limitation, industrial water filtration systems.

As used herein, references to “point of entry” are to be understood to refer to a location at which a supply of water from a water source, such as a municipal water distribution system or a well, for example, enters the building through a suitable inlet pipe. Further, as used herein, references to “point of use” are to be understood to refer to a location within or outside the building, such as at a sink or a water dispenser, where a user has access to water through suitable piping and/or connections.

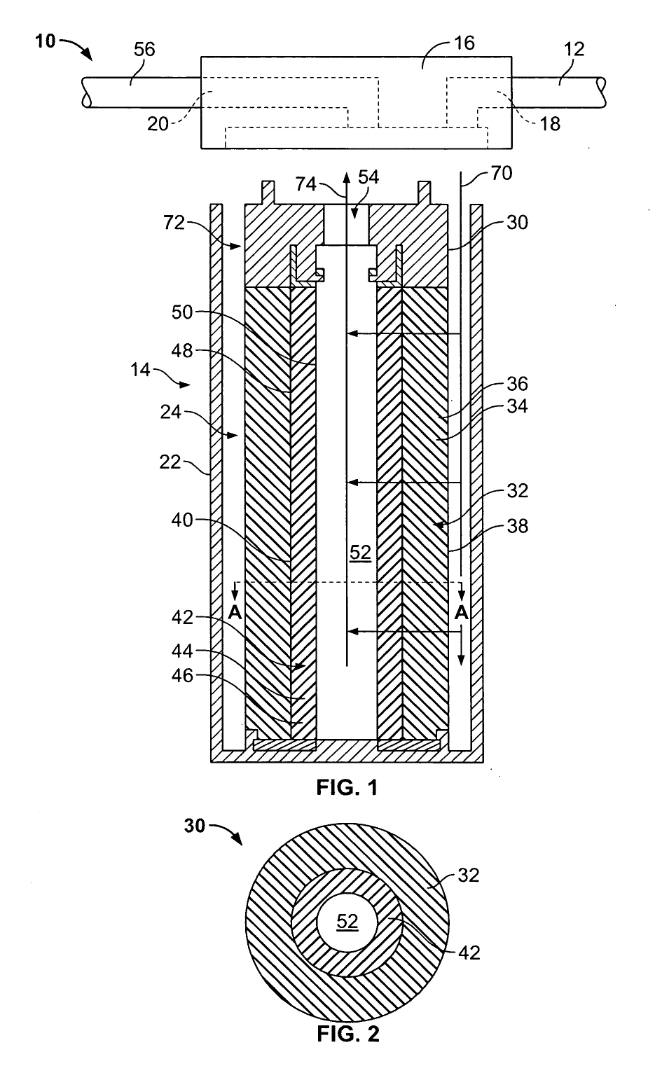

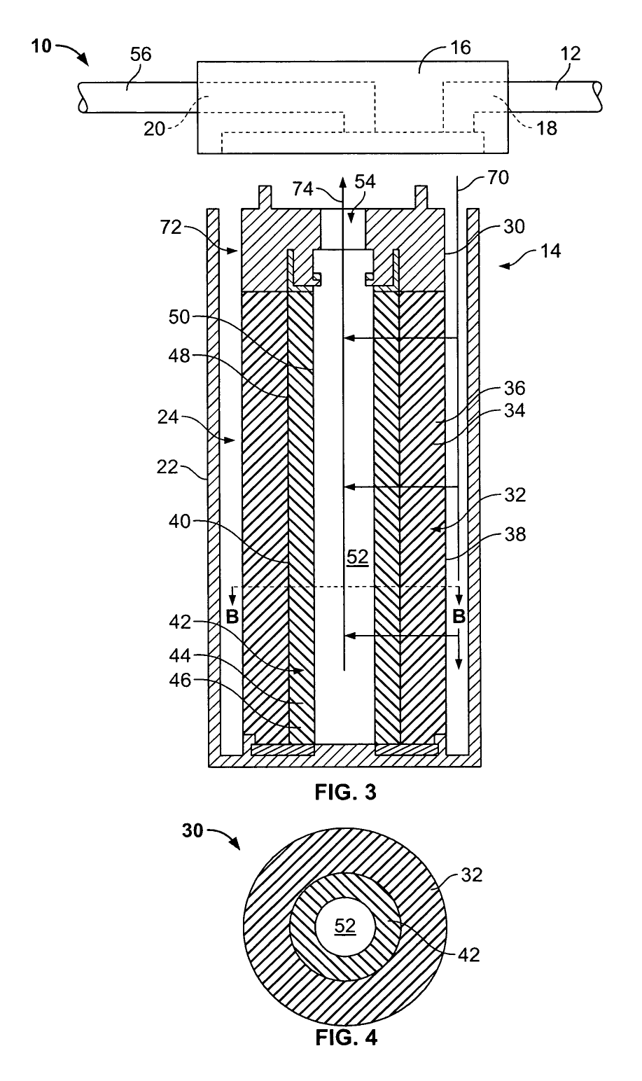

Referring to FIGS. 1-4, in one embodiment a water filtration system 10 for removing lead from water supplied by a water source (not shown) includes an inlet pipe 12 and/or any suitable piping or connection in fluid communication with the water source, such as a municipal water distribution system. A filter assembly 14 is operatively coupled to inlet pipe 12 such that inlet pipe 12 provides fluid communication between the water source and filter assembly 14. In one embodiment, filter assembly 14 is coupled to a filter assembly cap 16, as schematically shown in FIGS. 1 and 3. Filter assembly cap 16 includes an inlet 18 and an outlet 20 and is configured to direct water to flow through inlet pipe 12 and into filter assembly 14. After the water is filtered through filter assembly 14, the filtered water is directed through outlet 20 in filter cap assembly 16 for distribution.

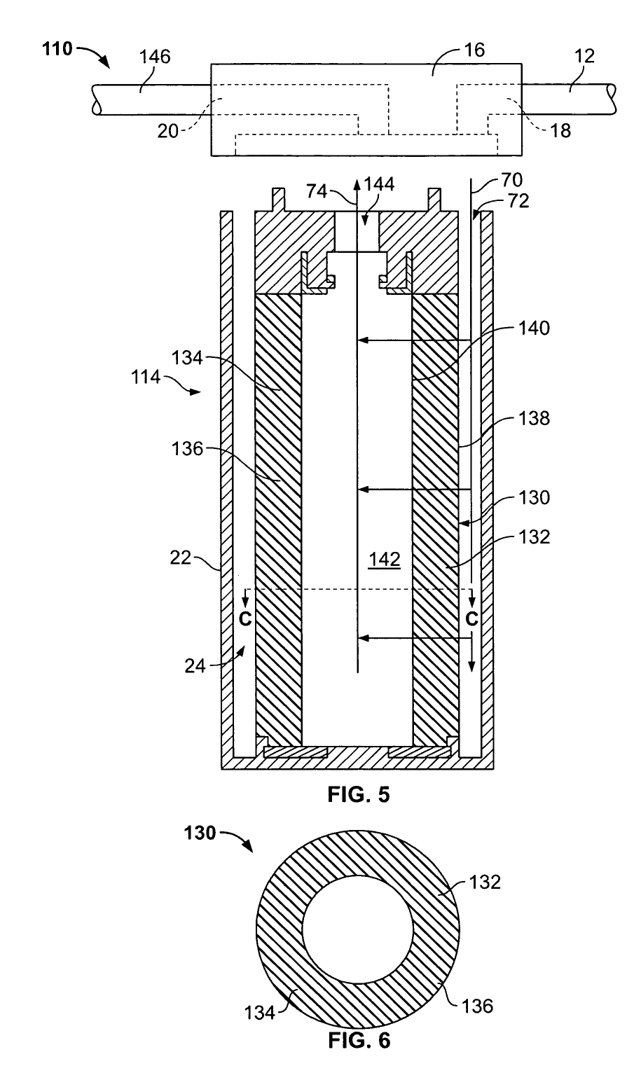

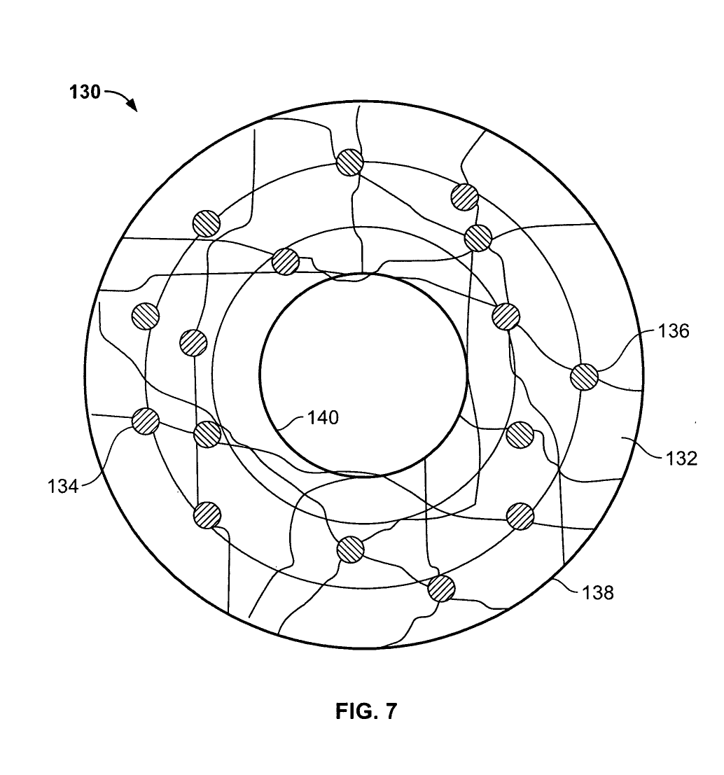

Filter assembly 14 is configured to filter source water to remove lead, as well as other contaminants, therefrom and provide filtered water suitable for user consumption. Referring to FIG. 1, in one embodiment, filter assembly 14 includes a housing 22 that defines a chamber 24. Housing 22 is coupled to or integrated with filter assembly cap 16. In a particular embodiment, housing 22 is threadedly coupled to filter assembly cap 16. Chamber 24 has suitable dimensions to define a volume configured to receive and contain a filter, such as dual stage filter 30, as shown in FIGS. 1-4, or filter 130, as shown in FIGS. 5-7. As described in greater detail below, the filter includes at least two filter media configured to facilitate removing undesirable contaminants including, without limitation, insoluble colloidal lead and soluble lead, from the source water. In one embodiment, the filter includes a support matrix and absorbent media that are embedded, dispersed or contained within the support matrix.

Referring further to FIGS. 1-4, dual stage filter 30 includes a primary or first filter medium or screen 32 and/or a secondary or second filter medium or screen 42 (described below). In one embodiment, as shown in FIGS. 1 and 2, first filter medium 32 is configured to remove and adsorb soluble lead to facilitate removing soluble lead from the source water. In an alternative embodiment, as shown in FIGS. 3 and 4, first filter medium 32 is configured to remove and adsorb insoluble colloidal lead from the source water.

Referring to FIGS. 1 and 2, in one embodiment first filter medium 32 is negatively charged to facilitate removing positively charged soluble lead from the source water as the source water is filtered through first filter medium 32. The removal of soluble lead is facilitated with the use of an adsorption medium that is capable of binding cationic lead through ionic interactions. In particular embodiments, first filter medium 32 is configured to remove all forms of soluble lead. As shown in FIG. 1, first filter medium 32 includes a support matrix 34 within which a first absorbent medium 36 is embedded, dispersed or contained. Support matrix 34 includes a suitable support material, such as a glass fiber, Fibredyne and/or polypropylene material. In one embodiment, first absorbent medium 36 includes a weak cation exchange resin and/or a ceramic cation adsorption medium, such as a titanium silicate ceramic material, commonly referred to as an ATS medium, manufactured by BASF/Engelhard Corp. located in Iselin, N.J., configured to adsorb soluble lead. In an alternative embodiment, first absorbent medium 36 is made of a suitable material to facilitate removing and adsorbing positively charged soluble lead from the source water. As shown in FIG. 1, support matrix 34 and/or first absorbent medium 36 is fabricated of a suitable support material formed in a cylindrical configuration to define a cylindrical side wall 38. Cylindrical side wall 38 further defines a first or inner core 40.

Dual stage filter 30 also includes second filter medium 42 operatively coupled in series with first filter medium 32 and contained within housing 22. In the embodiment shown in FIGS. 1 and 2, second filter medium 42 is positioned downstream from first filter medium 32 and is configured to remove and adsorb insoluble colloidal lead from the source water. The removal of negatively charged insoluble colloidal lead is facilitated with the use of a positively charged medium that attracts the negatively charged insoluble colloidal lead and removes the negatively charged insoluble colloidal lead from the source water.

Most insoluble colloids in water develop a surface charge that causes the insoluble colloids to repel one another and remain suspended in the water. These electrostatic charges are responsible for charged related phenomena in colloidal systems, such as flocculation and dispersion stability of dilute and concentrated suspensions. At a high pH, colloids are typically negatively charged, while at a lower pH colloids are often positively charged. The pH at which colloids are neutrally charged or where the charge on colloids changes from positive to negative is referred to as the isoelectric point (IEP), or the point of zero charge. The isoelectric point for different inorganic colloids can vary widely as a function of the different types of colloidal materials. For instance, the isoelectric point of silica is at a pH of about 2 to about 3, while that of activated alumina particles is at a pH of about 8 to about 9. Therefore, depending on the charge or the Zeta potential (negative or positive mV) of the inorganic colloidal materials within the source water, either a positively charged medium or a negatively charged medium is utilized to adsorb the charged insoluble colloidal materials.

In this embodiment, second filter medium 42 is configured to remove the insoluble colloidal lead by taking advantage of a negative electrostatic charge present on the insoluble colloidal lead suspended in the source water. At the pH found in drinking water, such as a pH of about 6.5 to about 8.5, insoluble colloidal lead is negatively charged. In a pH range of about 6.5 to about 8.5, a measured Zeta potential or charge of colloidal lead is typically in the range of −19 mV to −17 mV, respectively. Therefore, the isoelectric point (IEP) of the colloidal lead is less than 6.5, which is the lower limit for the pH of drinking water.

The aforementioned characterization of the insoluble colloidal lead indicates that a medium that is positively charged will attract the negatively charged insoluble colloidal lead and remove the negatively charged insoluble colloidal lead from the source water. Suitable types of materials for enhancing the electrostatic interactions with insoluble colloidal lead include, without limitation, activated alumina having an IEP of about 8.5 to about 9.1. A suitable material for second filter medium 42 may depend upon various parameters including, without limitation, the charge of the lead particles at the pH of the water from which the lead particles are to be removed.

Second filter medium 42 includes a support matrix 44 within which a second absorbent medium 46 is embedded, dispersed or contained. In one embodiment, second filter medium 42 includes an electropositive support matrix including activated alumina coated glass fibers, such as at least one layer of a NanoCeram® material manufactured by Argonide Corporation located in Sanford, Fla.

As shown in FIGS. 1 and 2, second filter medium 42 is positioned downstream from first filter medium 32 such that source water filtered through first filter medium 32 exits first filter medium 32 and is directed through second filter medium 42. Second filter medium 42 is positioned with respect to first filter medium 32 to facilitate removing colloidal lead not removed by first filter medium 32 prior to water exiting filter assembly 14. In one embodiment, second filter medium 42 is positioned within first core 40 defined by first filter medium 32. In this embodiment, second filter medium 42 is fabricated of a suitable support matrix 44 formed in a cylindrical configuration to define a cylindrical side wall 48. Cylindrical side wall 48 further defines a second or inner core 50 that at least partially defines an axial water conduit 52 that provides an axial flow path through dual stage filter 30. An outlet opening 54 defined by water conduit 52 is in fluid communication with outlet 20 defined in filter assembly cap 16. The source water is directed through dual stage filter 30 and the resulting filtered water exits dual stage filter 30 into water conduit 52. The filtered water is then directed to flow from water conduit outlet opening 54 through outlet 20 and into an outlet pipe 56 coupled to filter assembly cap 16. Outlet pipe 56 is configured to distribute filtered water throughout the building water piping system to suitable water dispensing fixtures, such as a sink faucet and/or a refrigerator water dispensing system, for example.

Water filtration system 10 is operable as a point of entry water filtration system wherein source water is filtered to remove lead and other undesirable contaminants before filtered water is distributed through the building water piping system to coupled point of use fixtures or connections, such as sink facets and/or drinking water dispensers. Alternatively, water filtration system 10 is operable as a point of use water filtration system wherein source water is distributed through the building water piping system to coupled point of use fixtures or connections. In this embodiment, filter assembly 14 is operatively coupled to the building water piping system at or near the point of use to filter the source water.

In an alternative embodiment as shown in FIGS. 3 and 4, second filter medium 42 is positioned downstream from first filter medium 32. In this alternative embodiment, first filter medium 32 is positively charged to remove and adsorb negatively charged insoluble colloidal lead from the source water and second filter medium 42 is negatively charged to remove and adsorb positively charged soluble lead from the source water. The source water is directed radially inwardly through first filter medium 32. As the source water exits first filter medium 32, the partially filtered source water is directed into negatively charged second filter medium 42, which is configured to adsorb positively charged soluble lead. As the source water is filtered through second filter medium 42, soluble lead is removed from the source water to provide filtered water suitable for user consumption. In a further alternative embodiment, second filter medium 42 is positioned upstream from first filter medium 32.

Referring further to FIG. 1, in one embodiment a method for removing lead from water supplied by a water source is provided. Water filtration system 10 is operatively coupled to the water source such that an influent flow of source water 70 is directed through water filtration system 10. Influent flow of source water 70 is directed to flow through inlet pipe 12 and inlet 18 defined in filter assembly cap 16 into filter assembly 14. More specifically, water flows through inlet 18 and into housing 22 such that the source water flows along an inner surface of housing 22. In one embodiment, a circumferential gap or space 72 is at least partially defined between the inner surface of housing 22 and first filter medium 32 to direct influent flow of source water 70 into filter 30. Influent flow of source water 70 is directed to flow radially inwardly through first filter medium 32 positioned within housing 22 towards axial water conduit 52. More specifically, as shown in FIG. 1, influent flow of water 70 is directed radially inwardly through cylindrical side wall 38 of first filter medium 32.

As influent flow of water 70 is filtered through first filter medium 32, positively charged soluble lead is removed from the source water and adsorbed onto negatively charged first adsorption medium 36. In a particular embodiment, at least a portion of insoluble colloidal lead within the source water is removed as the source water is filtered through first filter medium 32.

The flow of partially filtered source water is directed radially inwardly through second filter medium 42 positioned within first core 40. As the partially filtered source water is filtered through second filter medium 42, negatively charged insoluble colloidal lead is removed from the partially filtered source water and adsorbed onto positively charged adsorption medium 46. Effluent flow of filtered water 74 enters axial water conduit 52 and exits filter assembly 14 through outlet opening 54 as filtered water suitable for user consumption, as desired.

In an alternative embodiment, as shown in FIG. 3, influent flow of source water 70 is directed to flow radially inwardly through first filter medium 32 positioned within housing 22 towards axial water conduit 52. More specifically, influent flow of water 70 is directed radially inwardly through cylindrical side wall 38 of first filter medium 32. As influent flow of water 70 is filtered through first filter medium 32, negatively charged insoluble lead is removed from the source water and adsorbed onto positively charged adsorption medium 36. The flow of partially filtered source water is directed radially inwardly through second filter medium 42 positioned within first core 40. As the partially filtered source water is filtered through second filter medium 42, positively charged soluble lead is removed from the partially filtered source water and adsorbed onto negatively charged adsorption medium 46. Effluent flow of filtered water 74 enters axial water conduit 52 and exits filter assembly 14 through outlet opening 54 as filtered water suitable for user consumption, as desired.

In an alternative embodiment, a water filtration system 110 is similar to water filtration system 10, shown in FIGS. 1-4, and components of water filtration system 110 that are identical to components of water filtration system 10 are identified in FIG. 5 using the same element reference number. Water filtration system 110 includes a filter assembly 114 having a single filter 130 including a plurality of filter media configured to remove and adsorb soluble lead and/or insoluble colloidal lead from the source water. Referring further to FIGS. 5-7, filter 130 includes a support matrix 132 contained within housing 22. In one embodiment, support matrix 132 includes any suitable number of suitable inert porous materials, such as glass fiber, Fibredyne, polypropylene and/or other suitable materials. In a particular embodiment, support matrix 132 includes a suitable polypropylene material within which charged adsorption media are integrated, such as embedded, encapsulated, dispersed or contained within support matrix 132. The charged adsorption media may be integrated within support matrix 132 using any suitable process known to those skilled in the art and guided by the teachings herein provided, such as by doping into support matrix 132 the charged adsorption medium or media during the support matrix formation process.

At least one negatively charged adsorption medium 134, such as an ATS ceramic cation adsorption medium including titanium silicate manufactured by BASF/Engelhard and/or any suitable media having a negative Zeta potential capable of removing and adsorbing positively charged soluble lead from the influent water is integrated within support matrix 132. At least one positively charged adsorption medium 136, such as activated alumina and/or any suitable media having a positive Zeta potential capable of removing and adsorbing negatively charged insoluble lead from the influent water is also integrated within support matrix 132. In one embodiment, support matrix 132 further provides an open matrix for facilitating minimizing a pressure drop during flow of the influent water through the filter.

In a particular embodiment, as shown in FIG. 7, support matrix 132 includes a meltblown polypropylene support material. Charged adsorption media, such as negatively charged adsorption medium 134 and positively charged adsorption medium 136, capable of removing soluble lead and insoluble lead, respectively, are integrated within support matrix 132. Support matrix 132 is formed of a suitable support material formed in a cylindrical configuration to define a cylindrical side wall 138. Cylindrical side wall 138 further defines a first or inner core 140. Support matrix 132 includes a plurality of polypropylene filaments formed by a meltblown process into a nonwoven web of continuous filaments that extend throughout filter 130. The continuous nonwoven web has a longitudinal dimension, a lateral dimension and a depth dimension so as to define a three dimensional structural support matrix. The three dimensional structural support matrix has a high void volume into which lead adsorption media are incorporated without compromising the pressure drop across filter 130 during use.

In one embodiment, negatively charged adsorption medium 134 includes an inorganic adsorption medium, such as an ATS ceramic cation adsorption medium including titanium silicate manufactured by BASF/Engelhard and/or any suitable media having a negative Zeta potential capable of removing and adsorbing positively charged soluble lead from the influent water. Negatively charged adsorption medium 134 removes soluble lead by electrostatic charge adsorption of positively charged soluble lead. Positively charged adsorption medium 136 includes an inorganic adsorption medium, such as an activated alumina medium including crystalline boehmite (AlO(OH)) and/or any suitable medium having a positive Zeta potential capable of removing and adsorbing negatively charged insoluble lead from the influent water. Positively charged adsorption medium 136 removes insoluble lead by electrostatic charge adsorption of negatively charged insoluble lead.

In one embodiment, positively charged adsorption medium 136 is configured to remove the insoluble colloidal lead by taking advantage of a negative electrostatic charge present on the insoluble colloidal lead suspended in the source water, as described above. Suitable types of materials for enhancing the electrostatic interactions with insoluble colloidal lead include, without limitation, activated alumina having an IEP of about 8.5 to about 9.1. A suitable material for positively charged adsorption medium 136 may depend upon various parameters including, without limitation, the charge of the lead particles at the pH of the water from which the lead particles are to be removed. Positively charged adsorption medium 136 includes any suitable filter material to facilitate removing and adsorbing negatively charged insoluble colloidal lead from the source water.

Cylindrical side wall 138 at least partially defines an axial water conduit 142 that provides an axial flow path through filter 130. An outlet opening 144 defined by water conduit 142 is in fluid communication with outlet 20 defined in filter assembly cap 16. The source water is directed through filter 130 and the resulting filtered water exits filter 130 into water conduit 142. The filtered water is then directed to flow through outlet opening 144 through outlet 20 and into outlet pipe 56. Outlet pipe 56 is configured to distribute filtered water throughout the building water piping system to suitable water dispensing fixtures, such as a sink faucet and/or a refrigerator water dispensing system, for example.

Water filtration system 110 is operable as a point of entry water filtration system wherein source water is filtered to remove lead and other undesirable contaminants before filtered water is distributed through the building water piping system to coupled point of use fixtures or connections, such as sink facets and/or drinking water dispensers. Alternatively, water filtration system 110 is operable as a point of use water filtration system wherein source water is distributed through the building water piping system to coupled point of use fixtures or connections. Filter assembly 114 is operatively coupled to the building water piping system at or near the point of use to filter the source water.

Referring further to FIG. 5, in one embodiment a method for removing lead from water supplied by a water source is provided. Water filtration system 110 is operatively coupled to the water source such that an influent flow of source water 70 is directed through water filtration system 110. Influent flow of source water 70 is directed to flow through inlet pipe 12 and inlet 18 defined in filter assembly cap 16 into filter assembly 114. More specifically, water flows through inlet 18 and into housing 22 such that the source water flows along an inner surface of housing 22. In one embodiment, circumferential gap or space 72 is at least partially defined between the inner surface of housing 22 and support matrix 132 to direct influent flow of source water 70 into filter assembly 114. Influent flow of source water 70 is directed to flow radially inwardly through support matrix 132 positioned within housing 22 towards axial water conduit 142. More specifically, as shown in FIG. 5, influent flow of water 70 is directed radially inwardly through cylindrical side wall 138 of support matrix 132.

As influent flow of water 70 is filtered through support matrix 132, positively charged soluble lead is removed from the source water and adsorbed onto negatively charged adsorption medium 134 and negatively charged insoluble colloidal lead is removed from the source water and adsorb onto positively charged adsorption medium 136. Effluent flow of filtered water 74 enters axial water conduit 142 and exits housing 22 through outlet opening 144 as filtered water suitable for user consumption, as desired.

In an alternative embodiment, a bifunctional lead adsorption medium (not shown) capable of removing soluble lead and insoluble lead is integrated within support matrix 132 including a meltblown polypropylene support material. In a particular embodiment, the bifunctional lead adsorption medium is incorporated into the meltblown polypropylene support matrix 132 by doping in the bifunctional lead adsorption medium during the melt blowing process. The presence of a negatively charged adsorption medium and a positively charged adsorption medium facilitates removing lead, whether positively charged or negatively charged and/or soluble or insoluble, from the influent water.

In one embodiment, filter 130 does not rely upon depth filtration to remove the insoluble colloidal lead. Rather, lead removal is predominantly due to charge adsorption of the variously charged lead species to the filter media. Therefore, the porosity of support matrix 132 is desirably relatively high to preclude any significant pressure drop across filter 130. The presence of both positively charged and negatively charged adsorption media facilitates removing lead, whether positively charged or negatively charged and soluble or insoluble lead, respectively, from the influent water.

The above-described systems and methods for removing lead and other contaminants from source water provide filtered water suitable for user consumption. More specifically, the filter assemblies as described above are configured to remove soluble and insoluble colloidal (particulate) lead at pH values similar to those found in drinking water. The filter assemblies are suitable for use in a residential point of use (POU) or a residential point of entry (POE) filter application, as well as in industrial water purification applications. By directing the source water through a filter assembly that includes charged filter media, positively charged soluble lead is removed and adsorbed by at least one negatively charged adsorption medium and negatively charged insoluble colloidal or particulate lead is removed and adsorbed by at least one positively charged adsorption medium. As a result, drinkable filtered water can be reliably and efficiently distributed throughout a building water supply system.

Exemplary embodiments of systems and methods for providing filtered water suitable for user consumption are described above in detail. The systems and methods are not limited to the specific embodiments described herein, but rather, components of the system and/or steps of the method may be utilized independently and separately from other components and/or steps described herein. Further, the described system components and/or method steps can also be defined in, or used in combination with, other systems and/or methods, and are not limited to practice with only the systems and methods as described herein.

While the invention has been described in terms of various specific embodiments, those skilled in the art will recognize that the invention can be practiced with modification within the spirit and scope of the claims.

What is claimed is:

1. A filter for removing soluble and insoluble lead from water supplied by a water source, said filter comprising at least one charged filter medium configured to facilitate removing at least one of soluble lead and insoluble colloidal lead from the water.

2. A filter in accordance with claim 1 wherein said at least one charged filter medium further comprises a support matrix and a positively charged adsorption medium dispersed throughout said support matrix, said positively charged adsorption medium configured to facilitate removing negatively charged insoluble colloidal lead from the water.

3. A filter in accordance with claim 2 wherein said positively charged adsorption medium further comprises activated alumina including crystalline boehmite.

4. A filter in accordance with claim 2 further comprising a negatively charged adsorption medium configured to facilitate removing positively charged soluble lead from the water.

5. A filter in accordance with claim 1 wherein said at least one charged filter medium further comprises a support matrix and a negatively charged adsorption medium dispersed throughout said support matrix, said negatively charged adsorption medium configured to facilitate removing positively charged soluble lead from the water.

6. A filter in accordance with claim 5 wherein said negatively charged adsorption medium further comprises one of a weak cation exchange resin and a ceramic cation adsorption medium.

7. A filter in accordance with claim 5 further comprising a positively charged adsorption medium configured to facilitate removing negatively charged insoluble colloidal lead from the water.

8. A filter in accordance with claim 1 further comprising a support matrix comprising a plurality of meltblown polypropylene filaments, and a positively charged adsorption medium integrated within said support matrix and configured to facilitate removing negatively charged insoluble lead.

9. A filter in accordance with claim 8 further comprising a negatively charged adsorption medium integrated within said support matrix and configured to facilitate removing positively charged soluble lead.

10. A filter in accordance with claim 1 further comprising:
a first filter medium comprising a negatively charged material configured to facilitate removing positively charged soluble lead from the water; and
a second filter medium operatively coupled in series with said first filter medium, said second filter medium comprising a positively charged material configured to facilitate removing negatively charged insoluble colloidal lead from the water.

11. A filter in accordance with claim 10 wherein said second filter medium is positioned one of upstream and downstream from said first filter medium.

12. A filter in accordance with claim 10 wherein said first filter medium comprises a polypropylene support matrix including a titanium silicate material.

13. A filter in accordance with claim 10 wherein said second filter medium comprises an electropositive support matrix including a plurality of glass fibers coated with activated alumina comprising crystalline boehmite.

14. A filter assembly coupled to a water distribution system for removing soluble and insoluble lead from a water source, the water distribution system comprising a filter assembly cap in fluid communication with the water source and defining an inlet and an outlet, said filter assembly comprising:
a filter housing coupled to the filter assembly cap and in fluid communication with the water source, said filter housing configured to receive unfiltered water through the inlet; and
a filter positioned within the filter housing, said filter comprising at least one charged filter medium configured to facilitate removing insoluble colloidal lead from the water.

15. A filter assembly in accordance with claim 14 wherein an axial water conduit is defined through said filter, said axial water conduit in fluid communication with the outlet and configured to distribute filtered water.

16. A filter assembly in accordance with claim 14 wherein said at least one charged filter medium further comprises a support matrix and a positively charged adsorption medium integrated within said support matrix, said positively charged adsorption medium configured to facilitate removing negatively charged insoluble colloidal lead from the water.

17. A filter assembly in accordance with claim 16 wherein said positively charged adsorption medium comprises activated alumina including crystalline boehmite.

18. A filter assembly in accordance with claim 16 further comprising a negatively charged adsorption medium configured to facilitate removing positively charged soluble lead from the water.

19. A filter assembly in accordance with claim 16 wherein said support matrix further comprises a plurality of meltblown polypropylene filaments.

20. A filter assembly in accordance with claim 15 wherein said at least one charged filter medium further comprises:
a first charged filter medium comprising a negatively charged material configured to facilitate removing positively charged soluble lead from the water; and
a second charged filter medium operatively coupled in series with said first charged filter medium, said second charged filter medium comprising a positively charged material configured to facilitate removing negatively charged insoluble colloidal lead from the water.

21. A filter assembly in accordance with claim 20 wherein said second charged filter medium is positioned one of upstream and downstream from said first filter medium.

22. A method for removing soluble and insoluble lead from water supplied by a water source, said method comprising:
operatively coupling a filter assembly to the water source, the filter assembly comprising a housing in fluid communication with the water source and configured to receive unfiltered source water, and a filter contained within the housing, the filter comprising at least one charged filter medium configured to facilitate removing insoluble colloidal lead from the source water; and
removing insoluble colloidal lead from the source water as the source water is filtered through the at least one charged filter medium.

23. A method in accordance with claim 22 further comprising removing soluble lead from the source water as water is filtered through the at least one charged filter medium.

24. A method in accordance with claim 22 further comprising:
directing an influent flow of source water radially inwardly through a cylindrical side wall of the filter; and
directing an effluent flow of filtered water exiting the filter through an axial water conduit defined by the filter.

25. A method in accordance with claim 22 further comprising directing an influent flow of source water radially inwardly through a support matrix of the filter, the support matrix comprising a plurality of meltblown polypropylene filaments, a negatively charged adsorption medium integrated within the support matrix to remove positively charged soluble lead from the water and a positively charged adsorption medium integrated within the support matrix to remove negatively charged insoluble lead the water.
